(19) United States
(12) Patent Application Publication
(10) Pub. No.: US 2004/0265768 A1
(43) Pub. Date: Dec. 30, 2004

(54) Buccal tube

(76) Inventor: Lee H. Tuneberg, Sheboygan, WI (US)

Correspondence Address: Philip G. Meyers Law Office, Suite 302, 1009 Long Prairie Road, Flower Mound, TX, 75022, US

(21) Appl. No.: 10/862,054

(22) Filed: Jun. 4, 2004

Related U.S. Application Data
(60) Provisional application No. 60/476,524, filed on Jun. 7, 2003.

(51) Int. Cl. A61C 3/00

(52) U.S. Cl. 433/17

(57) ABSTRACT

An orthodontic buccal tube includes an elongated buccal tube body having a first end weld flange integral with the tube body extending from a first end of the buccal tube body, and a second end weld flange integral with the tube body extending from a second end of the buccal tube body. At least the first end flange has a maximum width greater than the width of the tube body end adjacent the first flange. In one variation, the second end weld flange buccal tube likewise has a maximum width greater than the width of the tube body end adjacent the second flange. The amount of the end flange widening is to a degree sufficient to allow sufficient room for welding without substantial splashing of weld material at the end openings of the tube. The tube preferably has a diameter (or minimum diameter, if not of uniform diameter) of less than about 0.06 inch.

This application claims priority of U.S. Provisional Patent Application Ser. No.: 60/476,524, filed Jun. 6, 2003.

### TECHNICAL FIELD

The invention relates to orthodontic devices and in particular to an improved buccal tube.

### BACKGROUND OF THE INVENTION

Buccal tubes for molars are used to hold the ends of orthodontic arch wires that exert forces on the teeth, the magnitude and direction of these forces depending on the therapeutic treatment. Buccal tubes can be fixed directly on the teeth with adhesive, or mounted on metal orthodontic bands surrounding each tooth, to which buccal tubes are welded. The latter conventional buccal tube for holding an arch wire includes a small metal tube having a pair of end flanges below the end openings that are welded to the outside of a tooth band. These flanges are the same width as the tube or narrowed relative to the tube.

Recently a need has been identified for smaller buccal tubes which are less expensive to fabricate and more comfortable for the wearer. However, as the tube width or diameter becomes smaller, it becomes more difficult to weld the end flanges without splashing the weld material into the end openings of the tube, making installation on a band difficult. The present invention addresses this problem.

### SUMMARY OF THE INVENTION

An orthodontic buccal tube according to the invention comprises an elongated buccal tube body having a first end weld flange integral with the tube body extending from a first end of the buccal tube body and a second end weld flange integral with the tube body extending from a second end of the buccal tube body. At least the first end flange has a maximum width greater than the width of the tube body end adjacent the first flange. In one variation, the second end weld flange buccal tube likewise has a maximum width greater than the width of the tube body end adjacent the second flange. The amount of the end flange widening is to a degree sufficient to allow sufficient room for welding without substantial splashing of weld material at the end openings of the tube. The tube preferably has a diameter (or minimum diameter, if not of uniform diameter) of less than about 0.06 inch. These and other aspects of the invention are discussed further in the detailed description that follows.

### BRIEF DESCRIPTION OF THE DRAWINGS

Referring now to the drawings wherein like numerals denote the same and similar features throughout:

FIG. 1 is a top view of a buccal tube according to one variation of the invention;

FIG. 2 is a perspective view of the buccal tube of FIG. 1;

FIG. 3 is a top view of another embodiment of a buccal tube according to the invention;

FIG. 4 is an end view of the tube of FIG. 3; and

FIG. 5 is a side view of the tube of FIG. 3.

### DETAILED DESCRIPTION

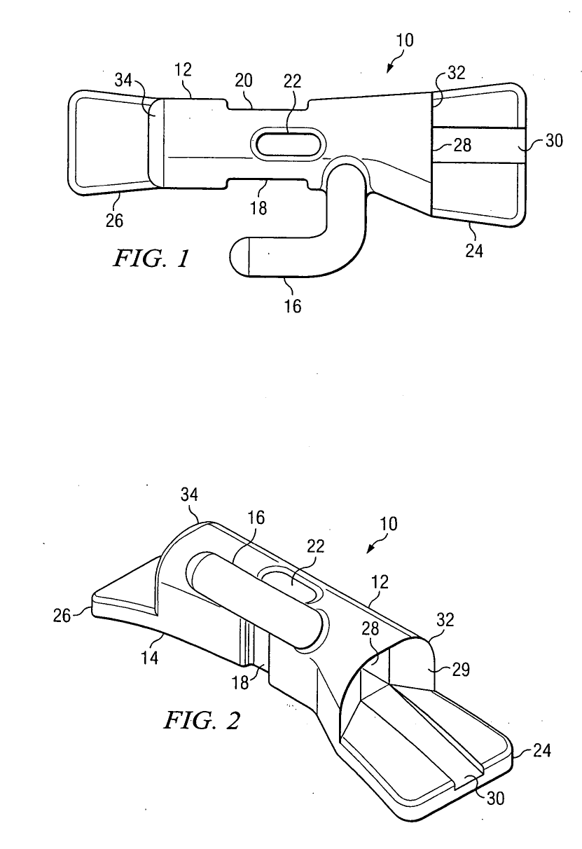

Referring to FIGS. 1 and 2, a buccal tube 10 according to the invention suitable for mounting on the outside of a metal band on a molar includes a tube body 12, base 14, and an outwardly protruding L-shaped hook 16. Hook 16 is used to attach or connect other dental accessories to buccal tube 10. Tube body 12 in this example is widened at its mesial end, but could have a uniform diameter along its length. Tube body 12 has opposed notches or indentations 18 and 20 on opposite outer sides thereof which facilitate grasping tube 10 with a tweezers or similar tool. Tube body 12 is also formed with a recess 22 on its outer face which may be engaged to aid in orienting and positioning the tube during installation on a base. A hole or bore 28 extends through tube body 12 in its lengthwise direction for receiving an arch wire. A tapered groove 30 is formed in the uppermost surface of first (mesial) end flange 24 for aiding in guiding an arch wire into hole 28. Hole 28 may have a circular or rectangular cross section depending upon the geometry of the particular arch wire used in connection with the tube, may be angled relative to the lengthwise axis of the axis of the tube in a manner known in the art. Hole 28 also may have an outwardly flaring mesial end portion 29 which further aids in guiding the arch wire into hole 28.

As illustrated, base 14 is curved to conform to a band or similar base used to mount the buccal tube upon a tooth and includes first and second end weld flanges 24, 26. Buccal tube 10 is secured to a tooth band or similar base by welding end flanges 24, 26 to a band or other base.

In a preferred embodiment, buccal tube 10 is unusually small, having a maximum width no greater than 0.06 inch. Such a narrow tube provides for reduced occlusal interference, reduced patient irritation and represents an improvement from an aesthetic and hygienic standpoint. Given this small tube size, it was found that splashing of welding material that occurs during the welding process interferes with the tube openings 28, hindering insertion of an arch wire. Conventional end flanges having the same width as tube body 12 did not provide enough space to permit welding without interfering with the tube openings, especially as to two weld spots which are normally formed near the end opening of the tube on either side of it.

Thus, according to one aspect of the invention, end weld flanges 24, 26 are formed as part of a integral buccal tube. At least one and preferably both end weld flanges 24, 26 are wider than the adjacent ends 32, 34 of the tube body 12, such that welding may be carried out with minimal splash interference with opening 28 at either of its ends. For the purpose of the invention and as used herein, “integral” refers to the fact that the tube body 12 and end flanges 24, 26 are made at the same time by a process such as casting, sintering, or powder metallurgy. This contrasts with parts made separately but welded together, which are not considered “integral” according to the invention. For example, it is known in the art to weld a buccal tube directly to a large underlying base plate, the ends of which would be wider than the tube in the occlusal-gingival direction. Such a plate and weld add additional height to the device (causing it to protrude further), and the weld is susceptible to corrosion.

In a preferred embodiment, end weld flanges 24, 26 flare gradually, widening as they extend outwardly from the same diameter as the tube to a width which is anywhere from 105-200%, preferably 105 to 130%, of the width of tube body 12 in the occlusal-gingival direction at the end adjoining the flange.

Depending upon the particular design and application, tube body 12 often has a uniform width, i.e., cylindrical shape, but in some cases one end of tube body 12 may be wider than the other. For example, as shown in FIG. 1, the mesial end 32 of tube body 12 is wider than distal end 34, but corresponding flanges 24, 26 are flared outwardly and are wider than the adjacent ends 32, 34 of the tube body.

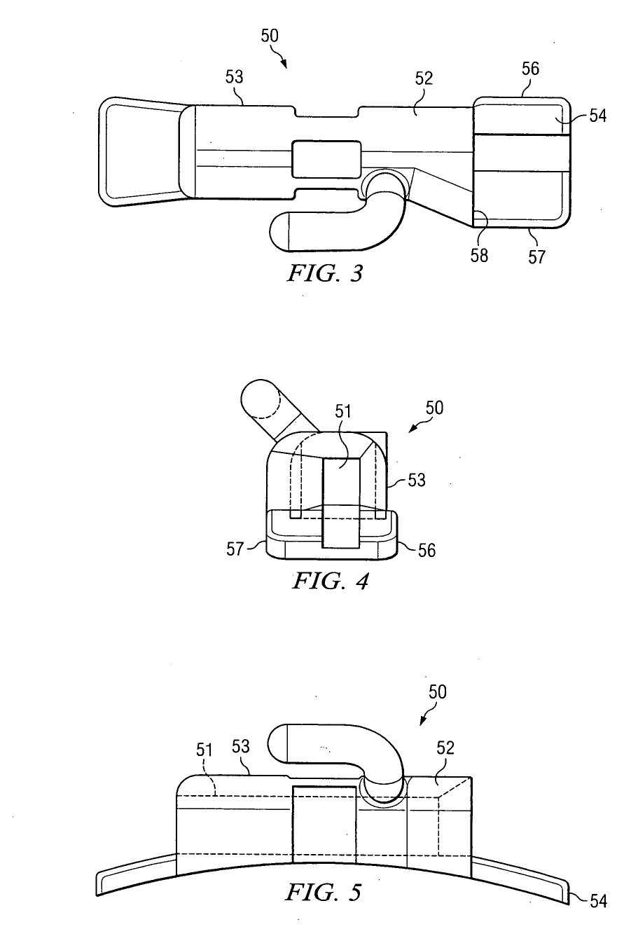

FIGS. 3-5 illustrate a further embodiment of a buccal tube 50 wherein the arch wire slot 51 is off center relative to a widened mesial end 52 of tube body 53. Due to this geometry, the associated end flange 54 is essentially rectangular but with a thin edge portion 56 on one side that extends beyond the width of tube body 53. The opposite edge 57 by contrast extends straight out and is aligned with the adjoining side 58 of tube body 53.

As will be appreciated, other end weld flange geometries could be used in the practice of the invention. For example, a rectangular or widened T-shaped flange could also be used, with somewhat greater difficulty. Further, the opening 28 in the tube body 12 may be angled to allow torque to be exerted on a tooth. In such a case, opening 28 may be set closer to one side of the tube end than the other. In such a case, it may be sufficient to widen one of weld flanges 24, 26 on one side (along one edge) only.

Those skilled in the art will appreciate that numerous changes and modifications may be made to the preferred embodiments of the invention and that such changes and modifications may be made without departing from the spirit of the invention. It is therefore intended that the appended claims cover all such equivalent variations as fall within the true spirit and scope of the invention.

1. An orthodontic buccal tube, comprising:
an elongated buccal tube body;
a first end weld flange integral with the tube body extending from a first end of the buccal tube body and having a maximum width greater than the width of the tube body end adjacent the first flange; and
a second end weld flange integral with the tube body extending from a second end of the buccal tube body.

2. The buccal tube of claim 1, wherein the second flange has a maximum width greater than the width of the tube body end adjacent the second flange.

3. The buccal tube of claim 1, wherein the first flange widens gradually from the tube body end adjacent the second flange to a remote end of the second flange.

4. The buccal tube of claim 1, wherein the second flange is located at a mesial end of the tube body and the first flange is located at a distal end of the tube body.

5. The buccal tube of claim 1, wherein a lengthwise buccal tube arch wire opening widens towards its distal end.

6. The buccal tube of claim 1, wherein the buccal tube is wider at its distal end than at its mesial end.

7. The buccal tube of claim 5, wherein the buccal tube is wider at its distal end than at its mesial end.

8. The buccal tube of claim 5, wherein the first flange widens gradually from the tube body end adjacent the second flange to a remote end of the second flange.

9. The buccal tube of claim 8, wherein the second flange is located at a mesial end of the tube body and the first flange is located at a distal end of the tube body.

10. An orthodontic buccal tube, comprising:
an elongated buccal tube body having first and second ends;
an arch wire hole extending lengthwise through said body;
first and second end weld flanges integral with said body extending from first and second ends of the buccal tube body, one of said first and second end weld flanges having a maximum width greater than the width of the tube body adjacent the end of the flange; and
a lengthwise slot formed in an upper surface of one of said flanges, said slot extending from an end of the arch wire hole for guiding an arch wire into the hole.

11. The buccal tube of claim 10 wherein the arch wire hole comprises first and second ends and wherein the arch wire hole widens from the first end to the second end.

12. The buccal tube of claim 10 wherein said end weld flanges each have a maximum width greater than the width of the tube body adjacent the end of the flange.
